(19) United States
(12) Patent Application Publication
(10) Pub. No.: US 2024/0132654 A1
(43) Pub. Date: Apr. 25, 2024

(54) MOULDED POLYURETHANE FLEXIBLE FOAMS HAVING IMPROVED DEMOULDING TIME

(71) Applicant: Huntsman International LLC, The Woodlands, TX (US)

(72) Inventors: Annelies VANDEVELDE, Everberg (BE); Herman Eugene Germain MOUREAU, Everberg (BE); Joris PITTEVILS, Everberg (BE); Veerle MOONS, Everberg (BE); Natasja GLORIE, Everberg (BE)

(21) Appl. No.: 18/278,308

(22) PCT Filed: Feb. 22, 2022
(86) PCT No.: PCT/EP2022/054444

§ 371 Date: Aug. 22, 2023

(30) Foreign Application Priority Data
Mar. 5, 2021 (EP) 21160849.2

(51) Int. Cl. C08G 18/18; C08G 18/10; C08G 18/16; C08G 18/48

(52) U.S. Cl. CPC C08G 18/1875; C08G 18/10; C08G 18/163; C08G 18/4808; C08G 18/485; C08G 2101/00; C08G 2110/0008; C08G 2120/00

(57) ABSTRACT

A reactive mixture and method for making a moulded flexible polyurethane comprising foam having a demould time <45 seconds, said reactive mixture comprising mixing at least following ingredients at an isocyanate index in the range 40-110.

### FIELD OF INVENTION

The present invention relates to cost efficient and improved methods for making moulded flexible foam thereby using Reaction Injection Moulding (RIM).

More in particular, the present invention relates to methods for lowering the demould time in Reaction Injection Moulding (RIM) processes for making moulded flexible polyurethane comprising foams thereby improving and/or maintaining a good moulding process such as good flow and filling of the mould in combination with good foam properties.

The present invention further relates to a reactive mixture for making moulded flexible foam thereby improving the demould time in a Reaction Injection Moulding (RIM) process.

Still further the present invention is concerned with moulded polyurethane comprising flexible foam, more in particular moulded polyurethane comprising flexible foams suitable for the production of acoustic materials.

### BACKGROUND OF THE INVENTION

Processing efficiency is critical in assessing the commercial viability of moulded polyurethane comprising flexible foams. Examples of these processing characteristics are more in particular the gel time and demould time among others. Gel time is critical in enabling complete filling of moulds before gelation occurs, particularly when large, complex moulds are utilized, while demould time is important in maximizing part production. Too long demould time necessitates larger numbers of relatively expensive moulds for a given part output. These requirements are often competing with the required moulded foam characteristics such as acoustic properties, open cell content, dimension stability (no shrinkage), modulus, loss factor, tensile strength, compression set in combination with the required density of the moulded product.

Various methods of decreasing demould time have been examined. Increasing catalyst level, for example, may often desirably influence these properties. However, increased catalyst levels may have a negative impact on the liquid flow and thus the filling of the mould and thus affect the desired visual aspect and shape of the moulded end product.

Primary hydroxyl-containing polyols have also been used to decrease demould time with some success, particularly in Reaction Injection Moulding (RIM) applications. However, in general, reliance on high primary hydroxyl polyols causes a decrease in gel time and moreover, may make the moulded foam more subject to adsorption of water due to the more hydrophilic nature of these polyols and possibly have an impact on the hardness of the moulded foam.

For all reasons above indicated there is a need to develop a reactive mixture for making moulded polyurethane comprising flexible foams which improves the demould time to achieve a more cost effective processing while maintaining the required product specifications specified by the automotive industry, optionally in combination with improving (increasing) the open cell content and avoiding shrinkage in the foam to further improve the acoustic properties.

### AIM OF THE INVENTION

It is an object of the present invention to provide a reactive mixture which is intended for the production of moulded polyurethane comprising flexible foam and which permits production of moulded polyurethane comprising flexible foam with more processing efficiency and thereby improving or at least maintaining the foam properties.

It is a further goal to achieve a moulded polyurethane comprising flexible foam with very good acoustic properties on the one hand and industrial standard processing on the other hand, while maintaining OEM (original equipment manufacturer) specific physical properties.

Surprisingly we have found a reactive mixture to improve (shorten) the demould time of the moulding process, optionally in combination with special additives for avoiding shrinkage (leading to improved open cell content) in the moulded flexible foam.

### DEFINITIONS AND TERMS

In the context of the present invention the following terms have the following meaning:
1) The isocyanate index or NCO index or index is the ratio of NCO-groups over isocyanate-reactive hydrogen atoms present in a formulation, given as a percentage:

$$\frac{[ N C O ] \times 100 ( \% )}{[ active hydrogen ]}$$

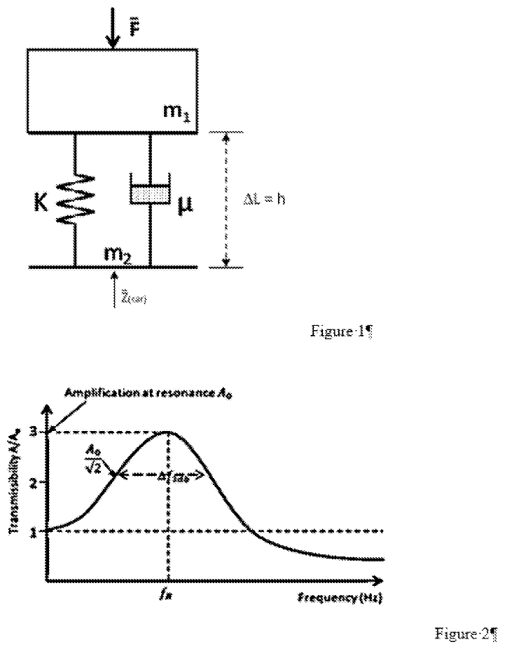

In other words the NCO-index expresses the percentage of isocyanate actually used in a formulation with respect to the amount of isocyanate theoretically required for reacting with the amount of isocyanate-reactive hydrogen used in a formulation.
It should be observed that the isocyanate index as used herein is not only considered from the point of view of the actual polymerisation process preparing the material involving the isocyanate ingredients and the isocyanate-reactive ingredients. Any isocyanate groups consumed in a preliminary step to produce modified polyisocyanates (including such isocyanate-derivatives referred to in the art as prepolymers) or any active hydrogens consumed in a preliminary step (e.g. reacted with isocyanate to produce modified polyols or polyamines) are also taken into account in the calculation of the isocyanate index.
2) The expression “isocyanate-reactive hydrogen atoms” as used herein for the purpose of calculating the isocyanate index refers to the total of active hydrogen atoms in hydroxyl and amine groups present in the reactive compositions; this means that for the purpose of calculating the isocyanate index at the actual polymerisation process one hydroxyl group is considered to comprise one reactive hydrogen, one primary amine group is considered to comprise one reactive hydrogen and one water molecule is considered to comprise two active hydrogens.
3) The term “average nominal hydroxyl functionality” (or in short “functionality”) is used herein to indicate the number average functionality (number of hydroxyl groups per molecule) of the polyol or polyol composition on the assumption that this is the number average functionality (number of active hydrogen atoms per molecule) of the initiator(s) used in their preparation although in practice it will often be somewhat less because of some terminal unsaturation.
4) The word “average” refers to number average unless indicated otherwise.
5) “Liquid” means having a viscosity of less than 10 Pa·s measured according to ASTM D445-11a at 20° C.
6) “pbw” means part by weight.
7) The term “room temperature” refers to temperatures of about 20° C., this means referring to temperatures in the range 18° C. to 25° C. Such temperatures will include, 18° C., 19° C., 20° C., 21° C., 22° C., 23° C., 24° C. and 25° C.
8) “Tensile strength” and “elongation” as referred to herein are both measured according to ISO 1798 Tensile strength is expressed in kPa and Elongation is expressed as %. Tensile strength is a measure of the amount of force required to break a foam sample. Elongation is a measure of the extent to which a foam sample can be stretched before it breaks and is expressed as a percentage of its original length.
9) The “density” of a foam is referring to the apparent moulded density as measured on foam samples by cutting a sample of the foam, weighing it and measuring its dimensions. The apparent density is the weight to volume ratio as measured according to ISO 845 and is expressed in kg/m³.
10) “E modulus” and “Loss Factor” are measured using Kelvin-Voigt model using viscous damper and purely elastic spring connected in parallel as shown in FIGS. 1 and 2 below and using following equations:

$${f}_{R} = \frac{1}{2 π} \sqrt{\frac{K}{{m}_{1} + {m}_{2}}}$$

$${f}_{R} = \frac{1}{2 π} \sqrt{\frac{{E}^{′} A}{( {m}_{1} + {m}_{2} ) h}}$$

$$μ = \frac{Δ {f}_{3 db}}{{f}_{R}} = \frac{Δ ( \frac{{A}_{0}}{\sqrt{2}} )}{{f}_{R}}$$

$$K = \frac{{E}^{′} A}{Δ L} = \frac{{E}^{′} A}{h}$$

$${f}_{R} = resonance frequency ( Hz ) \\ {E}^{′} = Dynamic modulus ( Pa ) \\ K = Stifness ( N / m ) \\ A = Area ( {m}^{2} ) \\ {m}_{1} = mass on top of foam ( kg ) \\ {m}_{2} = foam mass ( kg ) \\ {A}_{0} = Amplification at resonance \\ h = foam thickness ( m ) \\ μ = loss factor$$

### Test Specimen

Area: 50×50 mm.
Thickness: 10 mm till 25 mm with thickness tolerance between samples of the same specimen Δh=±5%.
Top mass (ml): 50 g ±4 g.

### Test Conditions

Test specimen should be conditioned for 24 hours at 23° C.±2° C. and 50% relative humidity ±5%.
Measurements: 4 measurements with 90° turn after each measurement.
Vibrational input: “white noise” signal in a frequency range of 1 Hz -200 Hz.
Frequency analysis by using a FFT (Fast Fourier transform) and calculation the transfer function A/Ao.
Calculate the Dynamic modulus E′ and the loss factor u according Kelvin-Voigt model.
11) The term “demould time” herein refers to the time (in seconds) after dispensing the liquid components of the reactive mixture into the mould and opening the mould.
12) The term “reactive mixture” in this invention refers to a combination of ingredients for making the moulded polyurethane comprising foam according to the invention wherein before reaction the polyisocyanate comprising compounds are kept in a container separate from the isocyanate-reactive compounds.
13) The term “thermolatent catalyst” refer in this invention to catalysts that have a delay in onset (initiation time) to catalyse the isocyanate-polyol reaction (polyurethane formation). Thermolatency means that the isocyanate-polyol reaction process due to the thermolatent catalyst is triggered by heat. The thermolatent catalysts useful in the current invention will be initiated at elevated temperatures (by elevated temperature it is meant, for example, a temperature above about 40° C. or higher) while standard polyurethane forming catalyst (herein referred to as non-thermolatent catalyst) do not need a temperature increase to initiate polyurethane formation and these catalysts are active at room temperature and below. The catalyst composition to be used in the current invention comprises a combination of thermolatent catalysts and non-thermolatent catalysts.
14) A “physical blowing agent” herein refers to permanent gasses such as CO₂, and N₂ as well as volatile compounds that expand the polymer by vaporization. The bubble/foam-making process is irreversible and endothermic, i.e. it needs heat to volatilize the (liquid) blowing agent.
15) A “chemical blowing agent” includes compounds that decompose under processing conditions and expand the polymer by the gas produced as a side product. Water can be regarded as a chemical blowing agent
16) “Cell-opening compounds” herein refers to compounds that will avoid shrinkage of the foam during and/or after the moulding process and as a result enhance the cell opening and open cell content of the foam. These compounds are therefore referred to in this invention as the “cell-opening compounds”.

### DETAILED DESCRIPTION

The present invention relates to a reactive mixture and a process for making moulded flexible polyurethane comprising foam such that both a short demould time (<45 seconds) and good mechanical and acoustic properties of the foam are achieved.

According to the invention, a reactive mixture and process for making moulded flexible polyurethane comprising foam having a demould time <45 seconds is disclosed. Said reactive mixture comprising at least mixing following ingredients at an isocyanate index in the range 40 -110:
a polyisocyanate prepolymer having an NCO-value of 10-32% and made by reacting a polyisocyanate composition comprising 30-90 wt % diphenylmethane diisocyanate (MDI) and 10-70 wt % homologues of said diisocyanate having an isocyanate functionality of 3 or more calculated on the total weight of the polyisocyanate composition with an isocyanate reactive composition comprising polyol compounds having an average molecular weight of 250-8000 and an average nominal hydroxyl functionality of 2-4,
an isocyanate reactive composition comprising:
   1) a first polyoxyethylene polyoxypropylene polyol having an average nominal hydroxy functionality of 2-6, an average molecular weight of 2000-8000, an oxyethylene content below 50 wt % calculated on the weight of this polyol, and
   2) a second polyoxyethylene polyoxypropylene polyol having an average nominal hydroxyl functionality of 2-6, an average molecular weight of 500-8000, an oxyethylene content of more than 50% by weight calculated on the weight of this polyol, and
   wherein the weight ratio of the first polyol to the second polyol is in the range 25/75 up to 95/5 based on the total weight of the first and second polyol.
0-5 wt % compounds which are obtained by reacting phthalic anhydride, succinic anhydride and/or trimellitic anhydride with a third polyol having an average equivalent weight of 100-2500 and an average nominal hydroxyl functionality of 2-8 and said wt % calculated on the total weight of the reactive mixture (cell-opening compounds), and
A catalyst composition comprising at least one non-thermolatent polyurethane forming catalyst compound and at least one thermolatent catalyst compound, and
A blowing agent composition comprising water, and
Optionally isocyanate-reactive chain extenders and/or cross-linkers having an average molecular weight of 60-1999, and
Optionally auxiliaries and additives.

According to embodiments, the demould time in the process for making moulded flexible polyurethane comprising foam according to the invention is less than 45 seconds, preferably less than 40 seconds, more preferably less than 35 seconds. Most preferably the demould time is in the range 25-35 seconds thereby using a closed mould process.

According to embodiments, the isocyanate index of the reactive mixture is in the range 40-110, preferably in the range 50-85, more preferably in the range 50-75.

According to embodiments the weight ratio of the first polyol to the second polyol is in the range 25/75 up to 95/5, more preferably in the range 40/60 up to 95/5, more preferably in the range 50/50 up to 95/5 based on the total weight of the first and second polyol.

According to embodiments, the first polyoxyethylene polyoxypropylene polyol having an average nominal hydroxy functionality of 2-6, an average molecular weight of 2000-8000, an oxyethylene content below 50 wt %, preferably an oxyethylene content in the range 8 wt %-50 wt %, more preferable an oxyethylene content in the range 10 wt %-30 wt % calculated on the total weight of the first polyol. A suitable example of a commercially available polyol is Daltocel® F 428 from Huntsman.

According to embodiments, the second polyoxyethylene polyoxypropylene polyol is having an average nominal hydroxy functionality of 2-6, an average molecular weight of 500-8000 and an oxyethylene content of more than 50% by weight calculated on the total weight of this second polyol. A suitable example of a commercially available polyol is Daltocel® F526 and Daltocel® F 444 from Huntsman.

According to embodiments, the second polyoxyethylene polyoxypropylene polyol is having an average nominal hydroxy functionality of 2-6, preferably an average nominal hydroxy functionality of 2-4, more preferably an average nominal hydroxy functionality of 2.5 up to 3.5.

According to embodiments, the at least one second polyoxyethylene polyoxypropylene polyol is having an average molecular weight of 500-8000, preferably an average molecular weight of 1000-6000, more preferably 1000-5000.

According to embodiments, the at least one second polyoxyethylene polyoxypropylene polyol is having an oxyethylene content of more than 50% by weight, preferably more than 60% by weight, more preferable more than 65% by weight, most preferably more than 70% by weight calculated on the total weight of this second polyol.

According to embodiments, the compounds which are obtained by reacting phthalic anhydride, succinic anhydride and/or trimellitic anhydride with a third polyol having an average equivalent weight of 100-2500 and an average nominal hydroxyl functionality of 2-8 will avoid shrinkage of the foam during and/or after the moulding process and as a result enhance the cell opening and open cell content of the foam. The third polyol used herein may be selected from polyester polyols, polyether polyols, polyester-amide polyols, polycarbonate polyols, polyacetal polyols and mixtures thereof. Preferably polyether polyols are used, like polyoxyethylene polyols, polyoxypropylene polyols, polyoxybutylene polyols and polyether polyols comprising at least two different oxyalkylene groups, like polyoxyethylene polyoxypropylene polyols, and mixtures thereof. The most preferred polyether polyols used here have an average nominal hydroxyl functionality of 2-4, an average equivalent weight of 100-2500, an oxyethylene content of at least 50% by weight and preferably of at least 65% by weight (on the weight of the polyether polyol). More preferably such polyether polyols have a primary hydroxyl group content of at least 40% and more preferably of at least 65% (calculated on the number of primary and secondary hydroxyl groups). They may contain other oxyalkylene groups like oxypropylene and/or oxybutylene. Mixtures of these most preferred polyols may be used.

No other polyols or other isocyanate-reactive compounds (than these most preferred polyether polyols) having an average equivalent weight of 100-2500 are used preferably. Such polyols are known in the art and commercially available; examples are Caradol® 3602 from Shell, Daltocel® F526, Daltocel® F442, Daltocel® F444 and Daltocel RF555 from Huntsman.

According to embodiments, the cell-opening compounds used in the reactive mixture according to the invention are obtained by reacting 1-10 wt %, preferably 2-7 wt % , most preferably around 5 wt % phthalic anhydride, succinic anhydride and/or trimellitic anhydride with a third polyol having an average equivalent weight of 100-2500, an oxyethylene content of more than 50 wt % and an average nominal hydroxyl functionality of 2-6, said wt % based on the total weight of the third polyol.

According to embodiments, the cell-opening compounds used in the reactive mixture according to the invention are obtained by reacting 1-10 wt %, preferably 2-7 wt % , most preferably around 5 wt % phthalic anhydride, succinic anhydride and/or trimellitic anhydride with a third polyol having an average equivalent weight of 100-2500, an oxyethylene content of more than 50 wt % and an average nominal hydroxyl functionality of 2-6 such that the ratio of the number of carboxylic acid groups to the number of ester groups, both formed in the reaction between the anhydride groups and the polyol, is 0.9-1.1 to 1 and wherein at least 60% of the anhydride groups has been converted,

According to embodiments, the cell-opening compound used in the reactive mixture according to the invention is selected from commercially available VITROX® bis 30050 available from Huntsman.

According to embodiments, the cell-opening compounds used in the reactive mixture according to the invention are obtained by reacting around 5 wt % phthalic anhydride, succinic anhydride and/or trimellitic anhydride with a third polyol which is selected from a polyether polyol with oxyethylene content of 93 wt %, a nominal hydroxyl functionality of 3.

According to embodiments, the catalyst composition according to the invention is comprising at least one non-thermolatent polyurethane gelling and/or blowing catalyst in combination with a thermolatent (delayed action) polyurethane catalyst, preferably a thermolatent gelling catalyst.

According to embodiments, the thermolatent catalyst compounds suitable for use in the catalyst composition according to the invention are selected from thermolatent catalysts selected from blocked tertiary amine-based gelling catalysts, preferably selected from blocked tertiary amine-carboxylic acid salts which need elevated temperatures to become active, or in other words such that the salt becomes unblocked. A commercially available suitable catalyst is Polycat® SA1/10, Polycat® SA2 LE, Polycat® SA 4, Polycat® SA 5 from Evonik and ToyocatR DB 30, ToyocatR DB 40, ToyocatR DB 60 from Tosoh.

According to embodiments, the at least one non-thermolatent polyurethane gelling and/or blowing catalyst suitable for use herein include, but are not limited to, metal salt catalysts, such as organotins, and amine compounds, such as triethylenediamine (TEDA), N-methylimidazole, 1,2-dimethylimidazole, N-methylmorpholine, N-ethylmorpholine, triethylamine, N,N′-dimethylpiperazine, 1,3,5-tris(dimethylaminopropyl)hexahydrotriazine, 2,4,6-tris(dimethylaminomethyl)phenol, N-methyldicyclohexylamine, pentamethyldipropylene triamine, N-methyl-N′-(2-dimethylamino)-ethyl-piperazine, tributylamine, pentamethyldiethylenetriamine, hexamethyltriethylenetetramine, heptamethyltetraethylenepentamine, dimethylaminocyclohexylamine, pentamethyldipropylene-triamine, triethanolamine, dimethylethanolamine, bis(dimethylaminoethyl)ether, tris(3-dimethylamino)propylamine as well as any mixture thereof. The catalyst compound should be present in the reactive composition in a catalytically effective amount. Commercially available non-thermolatent blowing and gelling catalyst are Jeffcat® DPA (typical gelling catalyst), Jeffcat® ZF10 (typical blowing catalyst), Jeffcat® Z130 (typical gelling catalyst), Dabco® NE300 (typical blowing catalyst), Dabco® NE1091 (typical gelling catalyst) and Dabco® NE1550 (typical gelling catalyst).

According to embodiments, the total amount of non-thermolatent polyurethane gelling catalyst in the catalyst composition according to the invention is in the range 0.3-3 wt %, preferably 0.3-2 wt % based on the total weight of the reactive mixture.

According to embodiments, the total amount of non-thermolatent polyurethane blowing catalyst in the catalyst composition according to the invention is in the range 0.15-0.5 wt %, preferably 0.18-0.4 wt % based on the total weight of the reactive mixture.

According to embodiments, the total amount of thermolatent polyurethane catalyst in the catalyst composition according to the invention is minimum 0.15 wt %, preferably in the range 0.15-0.4 wt %, more preferably 0.25-0.35 wt % based on the total weight of the reactive mixture.

According to embodiments, the total amount of catalyst compounds in the catalyst composition according to the invention is in the range 0.6-5 wt %, preferably 1-4 based wt % based on the total weight of the reactive mixture.

According to embodiments, the reactive mixture may further comprise an aldehyde scavenger. Said aldehyde scavenger preferably added in an amount of 0.05 up to 2 wt %, more preferably 0.1-2 wt % most preferably 0.1-1wt % calculated on the total weight of the reactive mixture and preferably said scavenger compound is selected from compounds like 4-hydroxycoumarin and/or acetoacetamide, JeffaddR AS-41, Jeffadd® AS-76, creatinine, 1-(2-hydroxyethyl)piperidine, malonic acid, dihydrazide, theophylline, 4-hydroxy-6 methyl-2-pyrone, cyanuric acid.

According to embodiments, the reactive mixture may further comprise additional polyols such as vegetable oil based polyols and/or modified vegetable oil based polyols having a molecular weight in the range 250-5000, preferably 800-3000 and which may be formed from at least one dimer fatty acid and/or at least one dimer fatty alcohol and/or at least one fatty acid and/or at least one fatty alcohol. Suitable examples of bio-based polyols are Castor oil based polyols, soy based polyol, rapeseed oil based polyol. Bio-based polyester-polyether polyols may be added to the reactive mixture in an amount of 0.5 up to 40 wt %, preferably 10 up to 40 wt %, more preferably 10 up to 36 wt % based on the total weight of the reactive mixture.

According to embodiments, the polyisocyanate prepolymer is made using a polyisocyanate composition 30-90 wt %, preferably 50-90 wt %, more preferably 60-80 wt % diphenylmethane diisocyanate (MDI) and 10-70 wt %, preferably 10-50 wt %, more preferably 20-40 wt % homologues of said diisocyanate having an isocyanate functionality of 3 or more calculated on the total weight of the polyisocyanate composition.

According to embodiments, the polyisocyanate prepolymer has an NCO value of 15-32%, preferably an NCO value of 20-32%, more preferably an NCO value of 25-32%.

According to embodiments, the organic polyisocyanates which may be used in the preparation of the polyisocyanate prepolymer in the reactive mixture of the invention include aromatic, aliphatic, cycloaliphatic and araliphatic polyisocyanates. Preferred polyisocyanates, however, are the aromatic polyisocyanates, for example phenylene diisocyanates, tolylene diisocyanates, 1,5-naphthylene diisocyanate and especially the available diphenylmethane diisocyanate (MDI) based polyisocyanates like MDI isomers, that is to say 4,4′-diphenylmethane diisocyanate, 2,4′-diphenylmethane diisocyanate and mixtures thereof.

More preferably the amount of 4,4′-diphenylmethane diisocyanate used as organic polyisocyanate is more than 50 wt %, preferably more than 60 wt %, more preferably more than 70 wt % calculated on the total weight of the organic polyisocyanate.

According to embodiments, the polyisocyanate prepolymer is made by reacting a polyisocyanate composition with an isocyanate reactive composition comprising polyol compounds having an average molecular weight of 2000-8000, more preferably an average molecular weight of 4000-8000, more preferably an average molecular weight of 5000-7000 and an average nominal hydroxyl functionality of 2-4. A commercially available prepolymer is Suprasec® 3231 from Huntsman.

According to embodiments, the polyisocyanate prepolymer is made by reacting a polyisocyanate composition with an isocyanate reactive composition having an average nominal hydroxyl functionality of 2-4 and comprising polyether, polyester and/or polyether-polyester polyol compounds having an average molecular weight of 2000-8000, more preferably an average molecular weight of 4000-8000, more preferably an average molecular weight of 5000-7000 and/or vegetable oil based polyols and/or modified vegetable oil based polyols having a molecular weight in the range 250 to 5000, preferably 800-3000.

According to embodiments, the vegetable oil based polyols and/or modified vegetable oil based polyols (if present) have a number average functionality usually in the range from 1.6 to 4.0, and preferably in the range from 1.9 to 3.0, per molecule.

According to embodiments, the polyisocyanate prepolymer is made by reacting a polyisocyanate composition with an isocyanate reactive composition having polyol compounds with an average nominal hydroxyl functionality of 2-4.

According to embodiments, the polyether polyols used for preparing the polyisocyanate prepolymer contain an average ethylene oxide content in the range 10-30 wt % based on the total weight of the polyether polyols.

Polyether polyols which may be used for preparing the polyisocyanate prepolymer include products obtained by the polymerisation of ethylene oxide with another cyclic oxide, for example propylene oxide or tetrahydrofuran in the presence of polyfunctional initiators. Suitable initiator compounds contain a plurality of active hydrogen atoms and include water and polyols, for example ethylene glycol, propylene glycol, diethylene glycol, dipropylene glycol, cyclohexane dimethanol, resorcinol, bisphenol A, glycerol, trimethylolpropane, 1,2,6-hexanetriol or pentaerythritol. Mixtures of initiators and/or cyclic oxides may be used.

According to embodiments, the blowing agent composition comprises mainly water. Preferably only water is used a blowing agent. The amount of water used as foaming agent, preferably in the absence of other blowing agents, may be varied in known manner in order to achieve the desired density. Suitable amounts of water are generally at least 0.3 wt %, preferably from 0.3-6 wt, more preferably 2-6 wt % calculated on the total weight of the reactive mixture.

According to embodiments, the additional blowing agents may be fluor based hydrocarbon compounds. A suitable fluor based hydrocarbon compound is Forane ® 365 (available from Arkema). The amount of fluor based hydrocarbon compound (if used alone) is in the range 2-6 wt % calculated on the total weight of the reactive mixture.

The reactive mixture further may comprise conventional additives like surfactants, colorants, stabilisers, fillers and mould release agents.

Preferably the chain extenders and cross-linkers are polyols having an hydroxyl functionality of 2-6 and preferably 2-4 and a molecular weight of 62-1999, more preferably 62-600 like ethylene glycol, (mono) ethylene glycol, diethylene glycol, propylene glycol, dipropylene glycol, butane diol, glycerol, trimethylolpropane, hexanediol, pentaerythritol and polyethylene glycols. Preferably the amount of chain extenders and cross-linker is preferably in the range 0.15-15 wt % calculated on the total weight of the reaction system.

The method for making the moulded flexible polyurethane comprising foam according to the invention comprises reacting the ingredients of the reaction system in a mould, most preferred said mould is a closed mould.

According to embodiments, the process for making moulded flexible polyurethane comprising foam according to the invention comprises at least the steps of:
i. pre-mixing the isocyanate reactive composition with the (optional)cell opener, the surfactants, the chain extenders and/or cross-linkers, the catalyst composition, the blowing agent composition (water) and other additives, and
ii. mixing the polyisocyanate prepolymer with the pre-mixed isocyanate reactive composition obtained in step i), and
iii. reacting the mixed polyisocyanate composition obtained in step ii) into a mould to obtain a reacted polyisocyanate composition, and then
iv. demoulding the obtained moulded flexible polyurethane comprising foam.

According to embodiments, the step of mixing of the polyisocyanate prepolymer with the pre-mixed isocyanate reactive composition obtained in step i) is performed using a 2 component high pressure mixing system.

According to embodiments, the step of mixing of the polyisocyanate prepolymer with the pre-mixed isocyanate reactive composition obtained in step i) is performed using a 2 component dynamic mixing system.

According to embodiments, the step of mixing of the polyisocyanate prepolymer with the pre-mixed isocyanate reactive composition obtained in step i) is preferably performed using a closed mould.

According to embodiments, the moulded flexible polyurethane comprising foam according to the invention is a moulded flexible foam having a moulded Density below 100 kg/m³ preferably in the range 40-80 kg/m³ measured according to ISO 845.

According to embodiments, the moulded flexible polyurethane comprising foam according to the invention is a moulded flexible foam having a E-modulus in the range 15-500 kPa, preferably in the range 15-150 kPa and more preferably 40-110 kPa.

According to embodiments, the moulded flexible polyurethane comprising foam according to the invention is a moulded flexible foam having a loss factor in the range 0.08-0.6%, preferably in the range 0.1-0.5% and more preferably 0.15-0.45%.

According to embodiments, the moulded flexible polyurethane comprising foam according to the invention is a moulded flexible foam having a compression set value at 50% measured according to ISO 1856 lower than or equal to 21% and more preferably lower than 15.

According to embodiments, the moulded flexible polyurethane comprising foam according to the invention is a moulded flexible foam having a tensile strength measured according to ISO 1856 >50 kPa, preferably >100 kPa and elongation >50% and more preferably >70% both measured according to ISO 1798.

According to embodiments, the moulded flexible polyurethane comprising foam are used in sound insulation applications in acoustic parts in automotive such as under carpet moulded foam in automotive floor mats, cavity fillings, engine covers, acoustic plug ins, dash insulator, . . .

The invention is illustrated with the following examples.

### EXAMPLES

### Chemicals Used

Polyisocyanate prepolymer Suprasec® 2310 from Huntsman
Polyoxyethylene polyoxypropylene polyol (polyol 1) having an average nominal hydroxy functionality of 2-6, an average molecular weight of 2000-8000, an oxyethylene content below 50 wt %
Polyoxyethylene polyoxypropylene polyol (polyol 2) having an average nominal hydroxyl functionality of 2-6, an average molecular weight of 500-6000, an oxyethylene content of more than 50 wt %
Water
Amine based non-thermolatent catalyst composition comprising a non-thermolatent gelling catalyst (JeffcatR DPA) and a non-thermolatent blowing catalyst (Dabco® NE-300)
Thermolatent catalyst (Polycat® SA2 LE)
Aldehyde scavenger
Diethanolamine (DELA)
Glycerol
Surfactant Tegostab® B 8734 LF2
Cell opening compound Vitrox® bis 30050 from Huntsman

### Examples 1-4 and Comparative Examples 1 and 2 Moulded Flexible Polyurethane Comprising Foam

The reactive mixture was prepared by mixing the polyisocyanate prepolymer with the isocyanate reactive composition comprising the polyols and further additives (water, catalysts, surfactants, chain extenders, . . . ). Subsequently the reactive mixture was injected into a closed mould at 60° C.

Examples 1, 2, 3 and 4 are according to the invention, the comparative examples 1 and 2 are using a reactive composition according to the state of the art. Table 1 below shows the composition of the reactive systems.

All examples are resulting in a moulded flexible polyurethane comprising foam suitable for use as dash insulator in automotive dashboards and under carpet moulded foam in automotive floor mats.

Table 1 below shows ingredients of the reactive mixture used to make the moulded flexible polyurethane comprising foam according to the invention (examples 1-4) and the comparative examples.

TABLE 1

| | Comp. | Comp. | | | | |
|---|---|---|---|---|---|---|
| | example 1 | example 2 | Example 1 | Example 2 | Example 3 | Example 4 |
| Polyisocyanate | 39.39 | 37.5 | 39.22 | 32.89 | 39.05 | 32.89 |
| prepolymer | | | | | | |
| polyol 1 | 49.62 | 51.16 | 48.78 | 53.84 | 50.14 | 55.23 |
| polyol 2 | 6.06 | 6.25 | 4.56 | 5.03 | 4.88 | 5.37 |
| Vitrox ® bis 30050 | — | — | 1.52 | 1.68 | — | — |
| Glycerol | 0.30 | 0.31 | 0.19 | 0.21 | 0.19 | 0.21 |
| Non-thermolatent | 0.61 | 0.62 | 1.50 | 1.66 | 1.5 | 1.65 |
| gelling catalyst | | | | | | |
| Non-thermolatent | 0.18 | 0.19 | 0.25 | 0.28 | 0.25 | 0.28 |
| blowing catalyst | | | | | | |
| Thermolatent | — | — | 0.30 | 0.34 | 0.31 | 0.34 |
| catalyst | | | | | | |
| Aldehyde | 0.18 | 0.19 | 0.18 | 0.20 | 0.18 | 0.17 |
| Scavenger | | | | | | |
| Surfactant | 0.27 | 0.28 | 0.27 | 0.30 | 0.27 | 0.30 |
| DELA | 0.15 | 0.16 | — | — | — | — |
| Water | 3.24 | 3.34 | 3.23 | 3.57 | 3.23 | 3.56 |
| Ratio I/100 P | 65.0 | 60 | 64.5 | 49 | 64.1 | 49 |
| index | 66.2 | 61.1 | 68 | 51.7 | 68 | 51.7 |
| Mould temp. (° C.) | 60 | 60 | 60 | 60 | 60 | 60 |
| Products temp. (° C.) | 40 | 40 | 40 | 40 | 40 | 40 |
| EOR (s) | 34 | — | 18 | — | 15 | — |
| DMT (s) | 45 | 45 | 30 | 30 | 30 | 30 |
| Open cell | 2 | 3.5 | 1 | 1.5 | 3 | 2 |
| 1 = open | | | | | | |
| 5 = closed | | | | | | |

TABLE 2

| | Test | | Comparative | | Example | | | |
|---|---|---|---|---|---|---|---|---|
| Parameter | method | Unit | 1 | 2 | 1 | 2 | 3 | 4 |
| Density | ISO 845 | kg/m³ | 51.6 | 56.6 | 54.2 | 52.3 | 47.4 | 54.3 |
| E Modulus | | kPa | 144 | 57 | 102 | 40 | 134 | 66 |
| Loss factor | | % | 0.38 | 0.29 | 0.24 | 0.22 | 0.25 | 0.26 |
| Compression set 50% | ISO 1856 | % | 19.6 | 19.5 | 14.1 | 15.6 | 20 | 15.6 |
| dry | | | | | | | | |
| Tensile Strength | ISO 1798 | kPa | 184.7 | 130.8 | 138.4 | 56.3 | 129.2 | 66.0 |
| Elongation | ISO 1798 | % | 78.4 | 72.9 | 71.5 | 75.2 | 76.1 | 81.6 |
| Open cell content | 1 = open | | 2 | 3.5 | 1 | 1.5 | 3 | 2 |
| | 5 = closed | | | | | | | |

Table 2 below shows the characteristics of the moulded flexible polyurethane comprising foam obtained by reacting the reactive composition according to Table 1.

1. A reactive mixture for making a moulded flexible polyurethane comprising foam having a demould time <45 seconds, said reactive mixture comprising a mixture of at least the following ingredients and an isocyanate index in the range 40-110:
a polyisocyanate prepolymer having an NCO-value of 10-32% and made by reacting a polyisocyanate composition comprising 30-90 wt % diphenylmethane diisocyanate (MDI) and 10-70 wt % homologues of said diisocyanate having an isocyanate functionality of 3 or more calculated on the total weight of the polyisocyanate composition with an isocyanate reactive composition comprising polyol compounds having an average molecular weight of 250-8000 and an average nominal hydroxyl functionality of 2-4,
an isocyanate reactive composition comprising:
1) a first polyoxyethylene polyoxypropylene polyol having an average nominal hydroxy functionality of 2-6, an average molecular weight of 2000-8000, an oxyethylene content below 50 wt % calculated on the weight of this polyol, and
2) a second polyoxyethylene polyoxypropylene polyol having an average nominal hydroxyl functionality of 2-6, an average molecular weight of 500-8000, an oxyethylene content of more than 50% by weight calculated on the weight of this polyol, and
wherein the weight ratio of the first polyol to the second polyol is in the range 25/75 up to 95/5 based on the total weight of the first and second polyol,
0-5 wt % compounds which are obtained by reacting phthalic anhydride, succinic anhydride and/or trimellitic anhydride with a third polyol having an average equivalent weight of 100-2500 and an average nominal hydroxyl functionality of 2-8 and said wt % calculated on the total weight of the reactive mixture (“cell-opening compounds”), and
a catalyst composition comprising at least one non-thermolatent polyurethane gelling catalyst compound in the range 0.3-3 wt % based on the total weight of the reactive mixture and at least one blowing catalyst compound in the range 0.15-0.5 wt % based on the total weight of the reactive mixture and at least one thermolatent polyurethane catalyst compound in the range 0.15-0.4 wt % based on the total weight of the reactive mixture, and
a blowing agent composition comprising water, and
optionally, isocyanate-reactive chain extenders and/or cross-linkers having an average molecular weight of 60-1999, and
optionally, auxiliaries and additives.

2. The reactive mixture according to claim 1 wherein the demould time is less than 45 seconds.

3. The reactive mixture according to claim 1 wherein the isocyanate index of the reactive mixture is in the range 40-110.

4. The reactive mixture according to claim 1 wherein the first polyol to the second polyol is in the range 25/75 up to 95/5, based on the total weight of the first and second polyol.

5. The reactive mixture according to claim 1 wherein the first polyoxyethylene polyoxypropylene polyol has an average nominal hydroxy functionality of 2-6, an average molecular weight of 2000-8000, an oxyethylene content below 50 wt calculated on the total weight of the first polyol and wherein the second polyoxyethylene polyoxypropylene polyol is having an average nominal hydroxy functionality of 2-6, and an average molecular weight of 500-8000, and an oxyethylene content of more than 50 wt % calculated on the total weight of this second polyol.

6. The reactive mixture according to claim 1 wherein the cell-opening compounds are obtained by reacting 1-10 wt phthalic anhydride, succinic anhydride and/or trimellitic anhydride with a third polyol having an average equivalent weight of 100-2500, an oxyethylene content of more than 50 wt % and an average nominal hydroxyl functionality of 2-6 such that the ratio of the number of carboxylic acid groups to the number of ester groups, both formed in the reaction between the anhydride groups and the polyol, is 0.9-1.1 to 1 and wherein at least 60% of the anhydride groups has been converted.

7. The reactive mixture according to claim 1 wherein the thermolatent catalyst is a blocked tertiary amine-based catalyst.

8. The reactive mixture according to claim 1 wherein the total amount of non-thermolatent gelling catalyst in the catalyst composition is in the range 0.3-2 wt % based on the total weight of the reactive mixture and the wherein the total amount of non-thermolatent polyurethane blowing catalyst in the catalyst composition according to the invention is in the range 0.18- 0.4 wt % based on the total weight of the reactive mixture.

9. The reactive mixture according to claim 1 wherein the total amount of thermolatent polyurethane catalyst in the catalyst composition is in the range 0.25-0.35 wt % based on the total weight of the reactive mixture.

10. The reactive mixture according to claim 1 wherein the total amount of catalyst compounds in the catalyst composition is in the range 0.6-5 wt %based on the total weight of the reactive mixture.

11. The reactive mixture according to claim 1 wherein the reactive mixture further comprises an aldehyde scavenger in an amount of 0.05 up to 2 wt %calculated on the total weight of the reactive mixture.

12. The reactive mixture according to claim 1 wherein the reactive mixture further comprises vegetable oil based polyols and/or modified vegetable oil based polyols having a molecular weight in the range 250-5000.

13. The reactive mixture according to claim 1 wherein the polyisocyanate prepolymer has an NCO value of 10-32% and said prepolymer is made using a polyisocyanate composition comprising 30-90 wt % diphenylmethane diisocyanate (MDI) and 10-70 wt % homologues of said diisocyanate having an isocyanate functionality of 3 or more calculated on the total weight of the polyisocyanate composition.

14. The reactive mixture according to claim 1 wherein the polyisocyanate prepolymer is made by reacting a polyisocyanate composition with an isocyanate reactive composition having an average nominal hydroxyl functionality of 2-4 and comprising polyether and/or polyether-polyester and/or polyester polyol compounds having an average molecular weight of 2000-8000 and/or vegetable oil based polyols and/or modified vegetable oil based polyols having a molecular weight in the range 250 to 5000.

15. The reactive mixture according to claim 1 wherein the amount of water in the blowing agent is in the range 0.3 wt % to 6 wt % calculated on the total weight of the reactive mixture.

16. The reactive mixture according to claim 1 wherein the amount of chain extenders and cross-linkers is in the range 0.15-15 wt % calculated on the total weight of the reactive mixture and are selected from polyols have an hydroxyl functionality of 2-6 and a molecular weight of 62-1999.

17. A process for making a moulded flexible polyurethane comprising foam having a demould time <45 seconds using the reactive mixture according to claim 1, said process comprises at least the steps of:
pre-mixing the isocyanate reactive composition with the cell-opening compounds, the catalyst composition, the blowing agent composition and, optionally, one or more of the following: the chain extenders and/or cross-linkers, auxiliaries, and additives, and
mixing the polyisocyanate prepolymer with the pre-mixed isocyanate reactive composition to form a mixed polyisocyanate composition, and
reacting the mixed polyisocyanate composition in a mould to obtain a reacted polyisocyanate composition, and then
- demoulding the obtained moulded flexible polyurethane comprising foam.

18. A moulded flexible polyurethane comprising foam made using the reactive mixture according to claim 1.
